(19) United States
(12) Patent Application Publication
(10) Pub. No.: US 2013/0325748 A1
(43) Pub. Date: Dec. 5, 2013

(54) NAVIGATION LOGIC CONSTRUCT FOR USE IN FORMULATION OF A RETIREMENT OUTCOME FRAMEWORK

(71) Applicants: Anil Suri, Jersy City, NJ (US); David Laster, Airmont, NY (US); Nevenka Vrodoljak, New York, NY (US); Michael J. Liersch, New York, NY (US)

(72) Inventors: Anil Suri, Jersy City, NJ (US); David Laster, Airmont, NY (US); Nevenka Vrodoljak, New York, NY (US); Michael J. Liersch, New York, NY (US)

(73) Assignee: BANK OF AMERICA, Charlotte, NC (US)

(21) Appl. No.: 13/485,548

(22) Filed: May 31, 2012

(51) Int. Cl. G06Q 40/06

(52) U.S. Cl. 705/36 R

(57) ABSTRACT

A method for navigating to one or more customized, goals-based retirement outcome solution(s) is provided. The method may include using a receiver to receive essential expense information from an investor. The method may further include using the receiver to receive income information from the investor. In addition to a receiver, the method may also use a processor. The method may include using the processor to calculate:

Max(Essential expenses−income,0)=AES
where (“AES”) represents the annual essential shortfall value (“AES”). The method may further include using the receiver to receive information corresponding to a lifetime real annuity rate. The method may also include using the processor to calculate:

AES/lifetime real annuity rate=EG
where (“EG”) represents an essential gap value.

### FIELD OF TECHNOLOGY

Aspects of the disclosure relate to developing a navigation logic construct for use in designing customized, goals-based retirement outcome solutions.

### BACKGROUND

Retirees depend on a reliable stream of income, but delivering this is only one part of an investment strategy. The challenges retirees face extend well beyond income to include myriad uncertainties. Retirement challenges cannot be solved with a financial calculator or a single investment solution. Preparing for retirement requires insight, forethought, and an array of solutions and ongoing course corrections. Ultimately, retirees should consider thinking beyond their desired retirement income, and seek their desired retirement outcome.

Thinking beyond retirement income empowers investors. By clarifying what is and is not possible and by knowing that they are creating the best possible retirement for themselves and their loved ones, investors gain peace of mind.

The need for a better approach to retirement is compelling. Some 78 million baby boomers will be filing for Social Security in coming years. The combination of volatile financial markets, record-low bond yields, longer life expectancy, the erosion of traditional pension plans and diminished confidence in Social Security necessitates a new approach to retirement.

It would be desirable to meld behavioral and financial concepts to create a superior, goals-based approach to retirement.

It would be further desirable to develop and provide a navigation logic construct for use in formulation of customized retirement outcome solutions where the navigation logic construct is based, at least in part, on the investor's mindset, the investor's investment approach and/or investment purpose.

### SUMMARY

A method for navigating a retirement outcome framework is provided. The method may include using a receiver to receive essential expense information from an investor. The method may further include using the receiver to receive income information from the investor. In addition to a receiver, the method may also use a processor. The method may include using the processor to calculate:

Max(Essential expenses−income,0)=AES

where (“AES”) represents the annual essential shortfall value (“AES”).

The method may further include using the receiver to receive information corresponding to a lifetime real annuity rate. The method may also include using the processor to calculate:

AES/lifetime real annuity rate=EG

where (“EG”) represents an essential gap value.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 illustrates a schematic diagram of a general-purpose digital computing environment in which one or more aspects of the present invention may be implemented;

FIG. 2 is a schematic diagram of an approach to determining an investor's personality;

FIG. 3 is a schematic diagram of an approach to determining an investor's retirement fitness;

FIG. 4 is a schematic diagram of a chart for navigating to a retirement outcome solution based on an investor's investment personality and retirement fitness;

FIG. 5 is a table showing key retirement goals associated with a retirement outcome framework and solutions for achieving them;

FIG. 6 is a table showing a comparison of retirement solutions;

FIG. 7A is a schematic diagram showing an characteristics of an exemplary investment personality;

FIG. 7B is a schematic diagram showing characteristics of an exemplary retirement fitness analysis;

FIG. 8 shows a comparison of a traditional investment solution and a retirement outcome solution;

FIG. 9 shows a breakdown of an embodiment of additional incremental spending obtained using a retirement outcome framework;

FIG. 10 shows a breakdown of the various sources utilized by a retirement outcome framework to generate income;

FIG. 11 shows another comparison of a traditional investment solution and a retirement outcome solution;

FIG. 12 shows yet another comparison of a traditional investment solution and a retirement outcome solution;

FIG. 13 shows an illustrative flow chart directed to a portion of a retirement outcome calculus;

FIG. 14 shows an illustrative flow chart relating to a portion of a retirement outcome calculus;

FIG. 15 shows yet another illustrative flow chart relating to a portion of a retirement outcome calculus;

FIG. 16 shows still another illustrative flow chart relating to a portion of a retirement outcome calculus;

FIG. 17 shows another illustrative flow chart relating to a portion of a retirement outcome calculus; and

FIG. 18 shows an illustrative flow chart relating to life insurance guidance as part of a retirement outcome solution.

### DETAILED DESCRIPTION OF THE DISCLOSURE

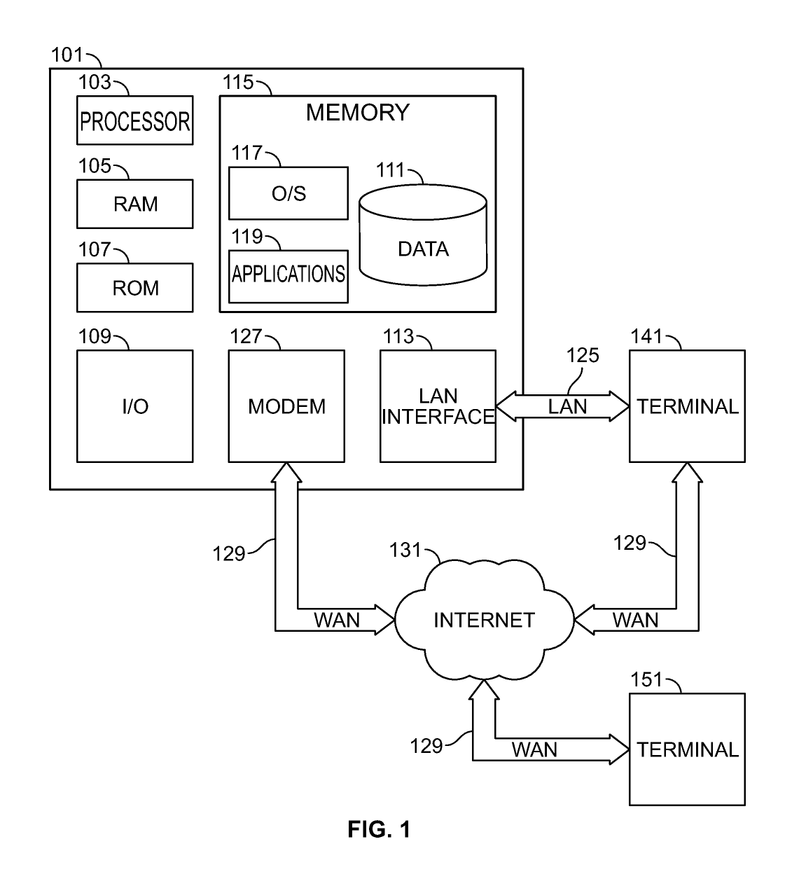

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115. Server 101 may include one or more receiver modules, server modules and processors that may be configured to transmit and receive payments, wire transfers, payments via checks, debit cards, credit cards, lines of credit or any suitable credit instrument. Likewise, server 101 may be configured to transmit and/or receive information and to provide from/to an Enterprise Resource Planner (“ERP”) or any other suitable system. Further, server 101 may provide confirmation information to one or more payees and facilitate payment approval processing and perform any other suitable tasks related to treasury operation within a cash positioning and reporting system.

Input/output (“I/O”) module 109 may include a microphone, keypad, touch screen, and/or stylus through which a user of device 101 may provide input, and may also include one or more of a speakers for providing audio output and a video display device for providing textual, audiovisual and/or graphical output. Software may be stored within memory 115 to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide storage for customer preferences, portfolio information, returns and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129 and/or Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in an investor-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, blackberry, smartphone, iPhone, or any other suitable device for storing, transmitting and/or transporting relevant information.

Any information described above in connection with database 121, and any other suitable information, may be stored in memory 115.

One or more of applications 119 may include one or more algorithms that may be used to perform one or more of the following: determination of the various terms necessary for formulation of the underlying metrics of navigation logic in a retirement outcome framework and any other suitable tasks related to systematic withdrawal programs, annuities or other instruments or operations related to the framework.

By drawing on a wide array of strategies, the navigation logic construct for use in formulation of a retirement outcome framework according to the invention creates solutions that enable investors to spend more each year while remaining confident of meeting their retirement goals. It accomplishes this by addressing several major financial concerns of retirees: health care risk, longevity risk, market risk and inflation risk.

The basic elements of the framework include: investment personality, retirement fitness, navigation and solutions. The navigation logic construct may be used for implementing the navigation aspect of the framework.

For the purposes of this application, the investment mindset may be understood to refer to the investor's comfort with, and willingness to take, investment risk.

For the purposes of this application the investment approach may be understood to refer to the elements, or solutions, that can be included in an investment strategy to help the investor stay profitably invested.

For the purposes of this application the investment purpose may be understood to refer to the reasons that the investor is investing, and whom he or she would like to benefit from his or her investment dollars.

The traditional approach to retirement guidance focuses on generating income to meet an investor's budgetary needs. This approach, while beneficial, gives short shrift to an investor's personal preferences. More recent approaches examine investing from a behavioral perspective, but lack analytical rigor.

A retirement outcome framework according to the invention melds the concepts of investment personality and retirement fitness to create a behaviorally and analytically rigorous, goals-based approach to retirement.

For the past few decades, broad diversification across asset classes has been the paradigm for financial advisors and asset managers.

The approach, according to the invention, may build on Markowitz's Nobel prize-winning work in modern portfolio theory. One often hears the mantra that asset allocation accounts for roughly 90% of investment performance.

But asset allocation is not enough for retirees. Many are concerned about outliving their wealth or not being able to fund their health care. Retirees can effectively protect themselves from these risks by going beyond a traditional investment focus, to purchase solutions that address longevity and health care risks.

The framework preferably includes a full gamut of investments and financial solutions in an open architecture. The aim is to provide the solution that is right for each individual or family.

With respect to the investment personality aspect of the invention, the framework includes a structured method to ascertain the investment personality of an investor, which can help the financial advisor and the investor jointly tailor a unique strategy best suited to achieving his or her goals.¹ ¹ Michael Liersch and Anil Suri, “Innovations in Behavioral Finance: How to Assess Your Investment Personality,” Merrill Lynch Wealth Management Institute, Spring 2012.

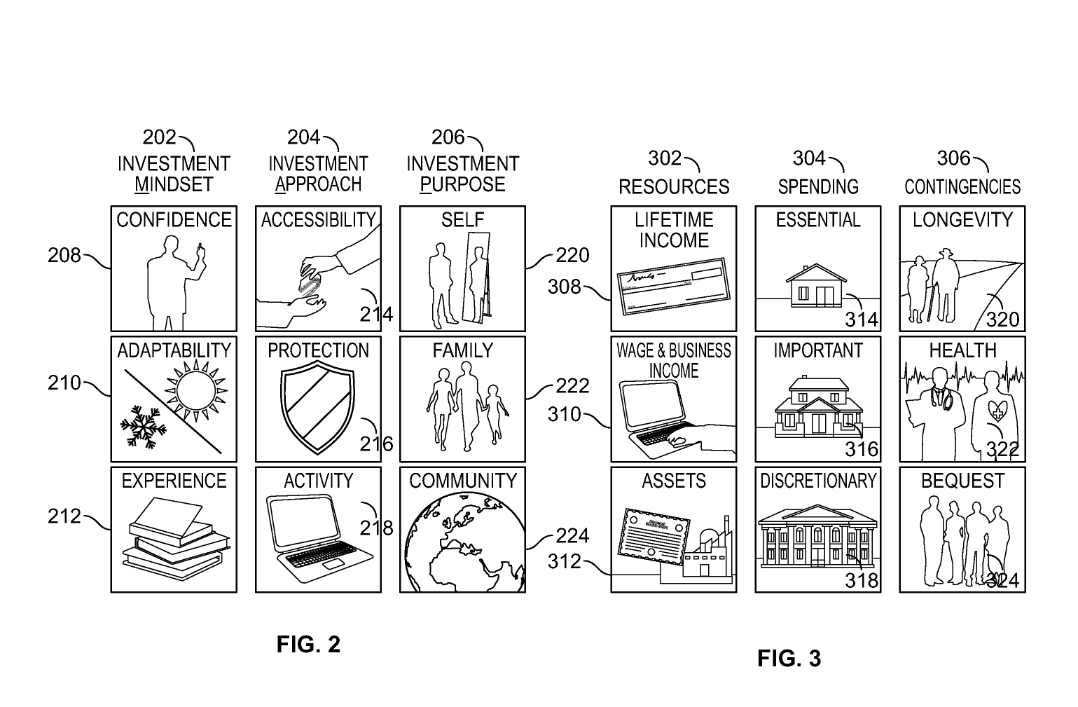

Based in behavioral finance research, the investment personality has three primary components: the investor's mindset 202 toward risk, his or her approach 204 to building an investment strategy and his or her purpose for investing, as shown in FIG. 2.

In the context of retirement, elements of one's investment personality—especially feelings about risk and loss—can prove critical to achieving successful outcomes. Understanding how market swings might influence an investor's decision making before initiating an investment strategy allows the investor and his or her financial advisor to invest in a way that better achieves the investor's retirement goals.

Assessing a retiree's mindset 202 can help optimize portfolio risk level, asset class exposure and level of investment complexity. For example, a retiree with little confidence 208 in the markets—possibly a consequence of events since the 2008 financial crisis²—could simply invest more conservatively. Alternatively, if the retiree must take on more risk to meet her goals and has the financial capacity to do so, then gradually placing money into the right investment strategy over time (i.e., dollar-cost averaging) can increase his or her comfort with risk. ² Lisa Shalett, “Another Look at Market Psychology: Reviving the Equity Culture,” IMG Investment Insights, July 2011.

A retiree's adaptability 210 to changing market environments and investment outcomes may also help determine the risks he or she would like to take. Although research suggests that most people are capable of adapting, many feel they cannot.³ Someone who believes he or she has a low capacity to adapt may favor cash or overly conservative investments. ³ David Schkade and Daniel Kahneman, “Does Living in California Make People Happy? A Focusing Illusion in Judgments of Life Satisfaction,” Psychological Science, Vol. 9, No. 5, 1998.

To increase his or her comfort with risk-taking, the retiree could consider less volatile asset classes (or eliminate more volatile exposures altogether) and focus on strategies that deemphasize moment-to-moment market returns (e.g., high-quality yield or income-based strategies).

Finally, when it comes to a retiree's mindset 202, experience 212 can matter.⁴ For example, less experienced retirees may incorrectly perceive more complex, unfamiliar investments (e.g., corporate bonds) as risky, and more simple, familiar investments (e.g., U.S. Treasuries) as risk-free.⁵ Openly acknowledging a retiree's familiarity with markets and investing can help bring the retiree and his or her financial advisor to a mutual understanding of the appropriate levels of risk and complexity. ⁴ For a review of studies examining how experience may eliminate differences in investment behavior previously attributed to gender, see Rachel Croson and Uri Gneezy, “Gender Differences in Preferences,” Journal of Economic Literature, Vol. 47, No. 2, June 2009.⁵ There is also evidence that people see risk and benefit as negatively correlated: Ali Siddiq Alhakami and Paul Slovic, “A Psychological Study of the Inverse Relationship between Perceived Risk and Perceived Benefit,” Risk Analysis, Vol. 15, No. 6, December 1994.

Some retirees who experience losses can become anxious, panicking during volatile markets because they feel out of control. Indeed, there is evidence that relative to younger investors, older investors are far more—even hyper—loss averse.⁶ Understanding a retiree's desire to feel in control during out-of-control times can help identify her desired level of accessibility 214 to her assets. Greater accessibility 214 can reduce the potential for higher returns, but can reassure the retiree that he or she can change her investment strategy at any time—which may, ironically, make him or her less likely to do so.⁷ ⁶ AARP and American Council of Life Insurers (ACLI). What Now? How Retirees Manage Money to Make It Last through Retirement. Report of Findings, 2007.⁷ For a discussion of ironic processes in mental control, see Daniel Wegner, “Ironic Processes of Mental Control,” Psychological Review, Vol. 101, No. 1, January 1994.

More accessible solutions (e.g., a municipal bond ladder) may make these changes to investment strategy less costly relative to less accessible ones (e.g., annuities).

Explicit protection 216 of investments can increase the retiree's comfort with an investment strategy by mitigating losses, enabling him or her to stay the course. This can be done using solutions that attempt to limit downside potential. For example, annuities or principal-protected, market-linked investments can offer higher levels of protection by explicitly preserving investment principal, though such guarantees can carry a high cost.

Finally, a key aspect of a retiree's Approach 204 is his or her desired level of investment activity 218. Retirees expressing a desire to be less active may prefer to delegate financial decision making to a financial advisor or other investment professional (e.g., money manager). Retirees who want the lowest level of activity may prefer not making any investment decisions once a strategy is set.

A critical element of investment success is to have a retiree and his or her financial advisor collaborate to understand how much, and in what way, the retiree would like to spend on his or herself 220—and what methods can make spending most efficient (e.g., tax-advantaged strategies). A retiree might often overlook self considerations, especially when he or she assigns a higher priority to the needs of his or her family or community. A low emphasis on self can, however, lead to a number of investment problems. A retiree might, for example, decumulate assets too quickly, causing poor outcomes for all.

A retiree may consider family 222 to be the primary purpose 206 for investing. While the retiree may have insured against longevity risk or invested for his or her grandchildren's education, he or she may not have accounted for other important elements of investing for his or her family.

For example, the retiree may not have explicitly addressed his or her children's own level of investment knowledge or discussed the differences in family members' investment.

Personalities (e.g., comfort with risk).⁸ ⁸ For suggestions on reaching younger generations about investing, see Michael Liersch, “What Behavioral Finance Has to Say about Generations X, Y and Z,” Merrill Lynch Wealth Management Institute, Spring 2012. See also Meir Statman, “Behavioral Finance Can Bring Generations Together,” Merrill Lynch Wealth Management Institute, Spring 2012.

Investing as a family can help address these needs: An investor can set up investment accounts for younger generations that they can manage together.

Investing for the community 224 is a major focus for many U.S. investors.⁹ Indeed, there is evidence that giving not only benefits others, but can increase the well-being of the giver.¹⁰ Clarifying what is important can help a retiree structure a philanthropic strategy—whether as an individual, as a family or as a bequest—that is most beneficial to all. Giving, like investing, comes with expectations and risks that a retiree should openly address when undertaking a philanthropic endeavor. ⁹ Still, average charitable giving by high net worth households in the U.S. decreased by about 35% during the recession years 2007 to 2009; The 2010 Study of High Net Worth Philanthropy, Bank of America Merrill Lynch and the Center on Philanthropy at Indiana University, November 2010.¹⁰ Elizabeth Dunn, Lara Aknin and Michael Norton, “Spending Money on Others Promotes Happiness,” Science, Vol. 319, No. 5870, March 2008.

An assessment of retirement fitness complements the investment personality assessment. Knowing an investor's retirement fitness enables the financial advisor to craft a strategy that helps an investor achieve his or her goals while staying secure. Retirement Fitness depends on an investor's resources, spending plans and contingencies (FIG. 3).

Retirees depend on the future lifetime income streams 308 that they have earned while working and on the wealth they have accumulated in other forms. The two most common lifetime income streams 308 are Social Security and employee pensions. In aggregate, lifetime income streams 308 represent 48% of income for families whose head of household is aged between 70 and 85. Among the most affluent decile of households in this age bracket, this share is 25%.¹¹ ¹¹ Based on author calculations using data from the Federal Reserve's 2007 Sur vey of Consumer Finances (SCF). Other data in this section also draw on the SCF.

Wage and business income 410 is another key resource for older households. For households headed by someone aged 55 to 62, wage and business income 410 represents 79% of total income. Its relative importance diminishes with age, to 54% of total income for those 62 to 70, and 25% for those 70 to 85.¹² ¹² The 25% figure is misleadingly high. Most families in the 70-85 age bracket earn no business or wage income; a minority earns large amounts of this income, boosting the average.

Assets 312 are another resource on which retirees can draw. A key challenge for retirees is to benefit from their assets 312 while preserving, and perhaps increasing, them. Assets 312 can be categorized as either financial or nonfinancial.

Financial assets 312 include bank accounts, 401(k) plans, IRAs and other investments. Nonfinancial assets can include a residence, other real estate or a business.

Many families have surprisingly few financial assets 312.

Among American families whose head of household is between the ages of 62 and 70, the median level of financial assets is $54,000, or enough to generate a lifetime income of about $300 per month.¹³ Older households with modest financial holdings must rely heavily on lifetime income streams 308 such as Social Security and pensions, perhaps supplemented with earnings 310. ¹³ This assumes a lifetime payout of about 6.7%, roughly in line with recent rates for immediate annuities.

In recent months, there has been much political rhetoric about “the 1%” of wealthiest Americans. Some may be surprised to learn that their resources place them, if not among the 1%, among “the 10%.” For example, whereas the median level of financial assets 312 for families headed by someone between the ages of 62 and 70 is $54,000, the highest decile in that age group holds median financial assets 312 of $869,000. Investors with approximately this level of financial assets are among the 10%. The second decile in this age group holds median financial assets 312 of $277,000.

A second basic component of retirement fitness is spending 304. An analysis according to the invention divides a retiree's spending 304 into three categories: essential, important and discretionary. Essentials 314 are the basics someone needs to survive, such as rent (or mortgage), utilities, health care, food, transportation and taxes. The most financially fit investors can easily cover these essential expenses with their lifetime income 308.

Discretionary expenses 318 are “wants” as opposed to “needs,” such as entertainment, gifts, travel or a vacation home. Important expenses 316 don't quite reach to the “want” level, but are somewhat before the essential level 314.

The level of these expenses is the key determinant of an investor's retirement fitness. Retirees who live within their means can meet their goals; those whose desired spending outstrips their resources cannot. Thus, there are some “wealthy” retirees with an annual income of $25,000 and some “poor” retirees with incomes of $250,000 or more.

The final component of retirement fitness is “contingencies” 306, which relate to longevity 320, health 322 and bequest 324.

Longevity risk 320 reflects how concerned investors are about the risk of outliving their wealth. Investors can pursue strategies to mitigate this risk. For example, they can bolster their lifetime income by purchasing an annuity that pays income for life;¹⁴ or they can purchase “longevity insurance,” which is a delayed annuity that pays income for life once an investor reaches a pre-specified age, such as 85. Yet another way for investors to address their longevity risk is by systematically allocating and drawing down assets according to their age and needs.¹⁵ ¹⁴ The role that immediate annuities can play for retirees is explored in David Laster and Anil Suri, “How Immediate Annuities Can Help Meet Retirement Goals,” Merrill Lynch Wealth Management, Summer 2011.¹⁵ For more on this, see David Laster, Anil Suri and Nevenka Vrdoljak, “Systematic Withdrawal Strategies for Retirees,” Merrill Lynch Wealth Management Institute, Winter 2012.

Health contingencies 322 relate to the health care concerns that can arise as people age. An important example is long-term care, whose costs can decimate an investor's financial wealth. By one estimate, almost 70% of people over 65 will need long-term care at one time or another.¹⁶ ¹⁶ U.S. Department of Health and Human Services, National Clearinghouse for Long Term Care Information, available at: http://www.longtermcare.gov/LTC/Main_Site/index.aspx. Long term care is the assistance people need to perform activities of daily living such as eating, bathing, continence, dressing, toileting and mobility. Long-term care needs typically arise as people age, but can also be due to a cognitive impairment, such as Alzheimer's disease, or an injury or illness, such as multiple sclerosis, stroke or rheumatoid arthritis.

Many rely on family to provide this care, but others prefer to fund it themselves. Pre-retirees and new retirees can hedge this risk by purchasing long-term care insurance.

Bequest 324 is the third category of contingencies. Leaving funds to loved ones or to philanthropic causes is a priority for many investors.

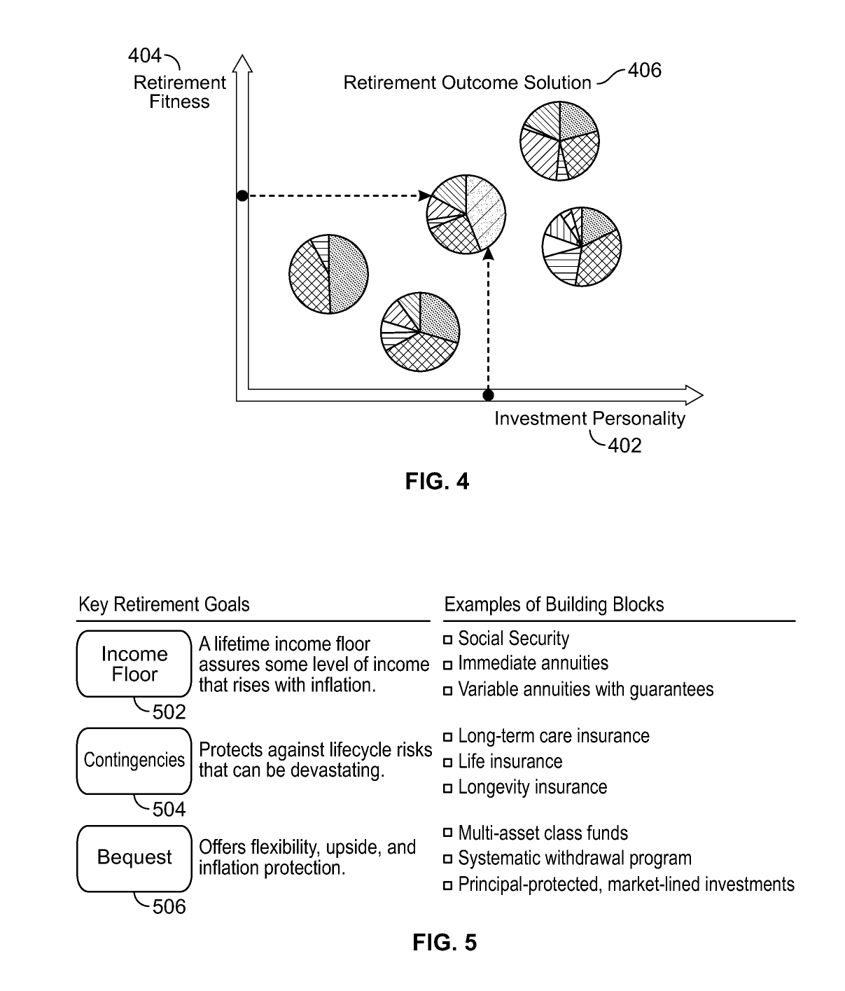

Armed with an understanding of the investor's investment personality and retirement fitness, a framework according to the invention navigates to a solution customized to the investor's situation 406 (FIG. 4).

Navigation to the retirement outcome solution can follow one of several approaches of increasing sophistication: subjective, heuristic and optimized. Subjective navigation depends on the judgment of subject-matter experts in areas such as annuities, long-term care and retirement planning. Heuristic navigation uses decision rules that are stress-tested and validated through quantitative analysis. It thus infuses expert opinion with additional rigor. Optimized navigation, an ideal approach to the retirement outcome challenge that has yet to be achieved, uses robust, innovative analytics. An analysis according to the invention uses subjective navigation.

A retirement outcome solution according to the invention includes three basic components (FIG. 5). A lifetime income floor 502 assures some level of income for life. Contingency protection 504 hedges against life-cycle risks that can be devastating.

The third component, inflation protection and bequest potential 506, offers flexibility and upside.

A retirement outcome solution moves beyond portfolio management and investment diversification to diversify across a range of investments and products.

The next section presents four brief exemplary studies. The names and details are fictitious, but the figures are based on data from the latest triennial Federal Reserve Board Survey of Consumer Finances. The Retirement Fitness of the studies reflects the mean and median values for households in the 62-70 and 70-85 age brackets whose net worth is in the highest decile of the U.S. population. Their investment personalities reflect a cross-section of affluent investors.

Rigorous analytics underlie the results. In selecting specific solutions, thousands of alternatives were tested using a Monte Carlo simulation calibrated to long-term Capital Market Assumptions.¹⁷ ¹⁷ See David Laster, Anil Suri and Nevenka Vrdoljak, “Pitfalls in Retirement,” Merrill Lynch Wealth Management Institute, Summer 2011, Table 2.

The analysis also models interest rate movements, long-term care costs and life expectancy based on reliable industry and government sources.

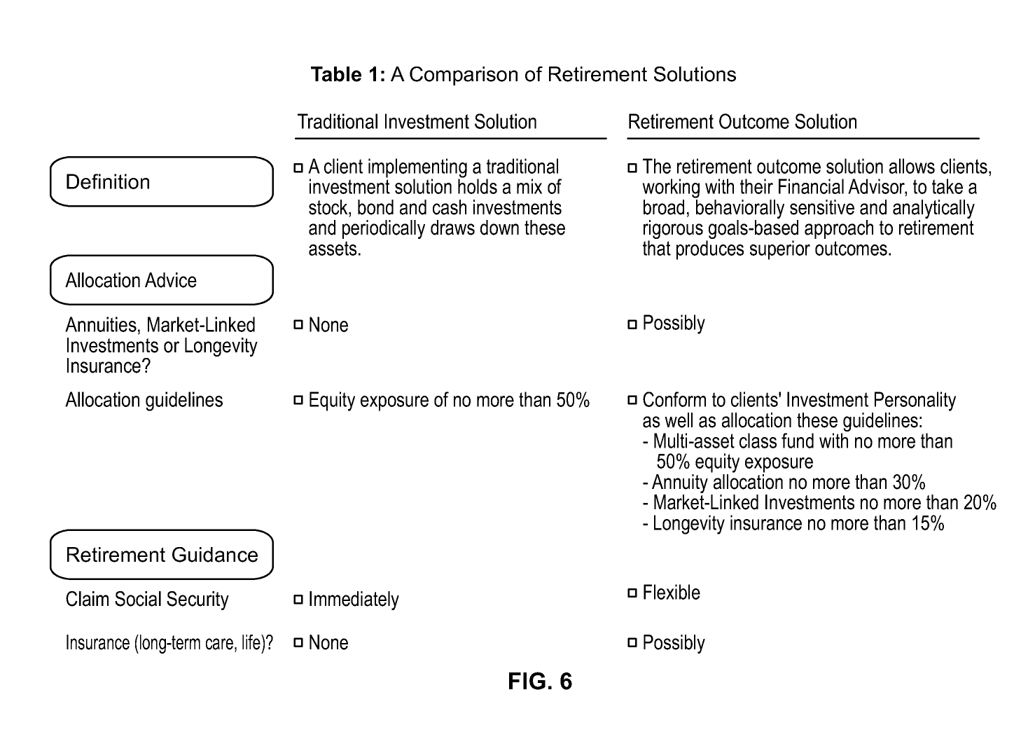

Next the application examines the guidance that the retirement outcome framework provides for several exemplary investors. To illustrate the advantages of retirement outcome solutions, the following four illustrative examples contrast them with the traditional investment solutions commonly in use today (FIG. 6).

An investor implementing a traditional investment solution 602 holds a mix of stock, bonds and cash funds and periodically draws down these assets. The investor regularly rebalances these holdings to a fixed allocation of stocks, bonds and cash.¹⁸ The strategy, which serves as a benchmark in this analysis, excludes annuities, market-linked investments and insurance. ¹⁸ The traditional investment solution is commonly known as a Systematic Withdrawal Program. For detailed guidance on this approach, “Systematic Withdrawal Strategies for Retirees,” op cit.

A retirement outcome solution 604 allows investors to take a broader approach. Some investors might purchase variable or immediate annuities, which can provide income for life, to help meet their spending needs.¹⁹ Others might opt for principal-protected, market-linked investments (MLI), which offer upside participation in markets while guaranteeing a return of principal should markets decline. For some investors, it may make sense to purchase long-term care insurance or life insurance. Another strategic option is for investors to delay the date on which they collect Social Security, thereby increasing their monthly benefits for life. ¹⁹ For more on the role of immediate annuities, see Merrill Lynch Wealth Management, “How Immediate Annuities Can Help Meet Retirement Goals,” op cit.

A retirement outcome solution 604 conforms to the investor's investment personality and reflects her preferences. For example:

Someone with a strong desire for protection might favor variable annuities or MLI;

An investor focused on accessibility might choose not to own any immediate annuities; and

An investor with a low capacity to adapt might limit her exposure to equities.

The retirement outcome framework according to the invention melds the investor's investment personality and Retirement Fitness to craft a behaviorally sensitive and analytically rigorous goals-based solution. Moreover, because the solution suits the investor's personality and priorities, she is more likely to adopt and stick with it.

The following is a group of exemplary questions that may be used to help formulate an investor personality. It should be noted that the following group is merely exemplary and one or more of these questions may be discarded, and other may be added. It should be noted as well that any predetermined subset of these questions may be grouped together in order to identify certain, preferably predetermined, aspects of the investment personality.

The answer to the following questions may be any one of the following choices—Strongly Disagree, Disagree, agree, Strongly agree. Such choices may be scored 1-4, or by any other suitable, preferably, numerical system.

1. I have spent many years—even decades—investing.

2. I can adjust my lifestyle and income needs to accommodate changes in market conditions and in the value of my investments.

3. I feel that I may have an unforeseen need for a large amount of money in the future.

4. Risk may yield financial benefits if I wait long enough.

5. I believe my own financial house should be in order before investing for—or giving money to—family members or the community at large.

6. My family is the most important part of my life.

7. I would personally like to make regular changes to my investment approach in an attempt to improve my investment returns.

8. I have no interest in leaving behind a substantial sum of money to a charity or a nonprofit.

9. I do not worry about losing my principal (or original investment).

10. I feel most comfortable knowing that I can rely on a steady stream of income, yield or return from my investments.

11. My children, parents or significant other depend(s) on me financially.

12. Following market news and reading investment-related publications or books is something that I do on a regular basis.

13. I understand that the possibility of losing money is part of the investment process.

14. I am investing enough for my future and have no concern that I may outlive the money I have accumulated.

15. Just thinking about financial markets makes me anxious—even when markets are going up.

16. I want the ability to withdraw money from some of my investments at any point in time—regardless of the cost.

17. I know less than the average investor about financial markets and investing in general.

18. The flexibility to change my investment approach dramatically—at a moment's notice—is important to me, even though it may come at a cost.

19. Being involved in detailed, day-to-day investment decisions is important to me.

20. The charities and nonprofits with which I am involved are the most important part of my life.

21. Losing even a small amount of money can make me feel anxious.

22. A financial advisor or money manager can help me make investment decisions that can enhance investment outcomes.

23. I enjoy giving money to charities or other nonprofit organizations.

24. I do not need to leave behind a substantial sum of money to family members.

25. To me, investing is something that everyone should take part in. Sure, there are some risks, but the potential rewards are worth it.

26. Spending my principal (or original investment) is something I would prefer not to do.

27. Generating a dependable stream of income is my primary reason for investing.

In some embodiments, investor reaction to: Q4, Q25 and Q15 may relate to an investor confidence score; investor reaction to Q2, Q10 and Q26 may relate to an investor adaptability score; and Q1, Q12 and Q17 may relate to an investor experience score. In some embodiments, investor reaction to: Q3, Q16 and Q18 may relate to asset accessibility; Q21, Q9 and Q13 may relate to asset protection; and Q7, Q19 and Q22 may relate to investor activity.

In some embodiments investor reaction to: Q5, Q27 and Q14 may relate to an investor's attitude towards the importance of investing for his or herself; Q6 Q11 and Q24 may relate to an investor's attitude toward investing for his family; and Q8, Q20 and Q23 may relate to an investor's attitude toward investing for his or her community.

For the purposes of illustrating the embodiments, we have relied on an exemplary set of assumptions regarding a number of fictitious case studies. In the analysis that follows, all of the retirement solutions consider conforming to basic, exemplary guidelines which are based on the assumptions. It should be noted that the characterizations of each of the fictitious characters include scores (not shown here) which could have been derived from the queries that parallel, or are similar to, the foregoing queries. This application attributes to the characters a predetermined investment personality. Instead of utilizing a set of scores, this patent application is directed to pre-formulated, fictitious, personality traits for the sake of illustration.

In particular, investors: do not allocate more than 50% of their retirement portfolios to equities; allocate no more than 30% to variable and immediate annuities;²⁰ allocate no more than 20% of their retirement portfolio to MLI; and use MLI to help fund future important and discretionary expenses, but not essential expenses.²¹ Nevertheless, it should be understood that these guidelines are merely exemplary and other, different, guidelines are also within the scope of this patent application. ²⁰ A further assumption in this analysis is that longevity insurance, which is an annuity that makes payments for life once the purchaser reaches a certain age, is no more than 15% of the overall portfolio.²¹ Annuities and MLI entail credit risk, which investors can mitigate by only buying contracts from issuers that are financially sound and by limiting their exposure to any one issuer.

### Exemplary Embodiment 1

### The Bakers

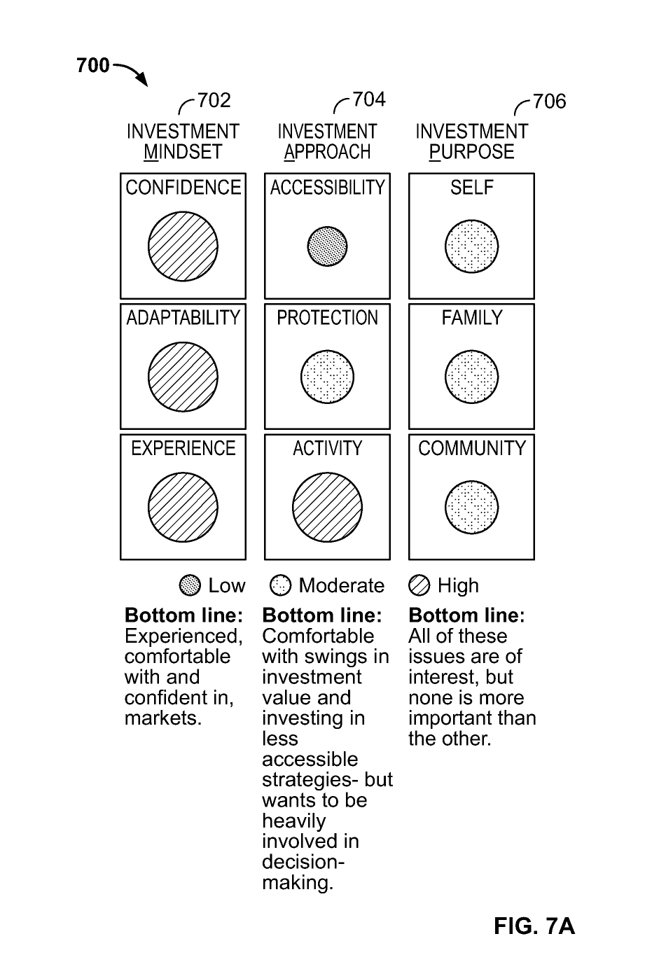

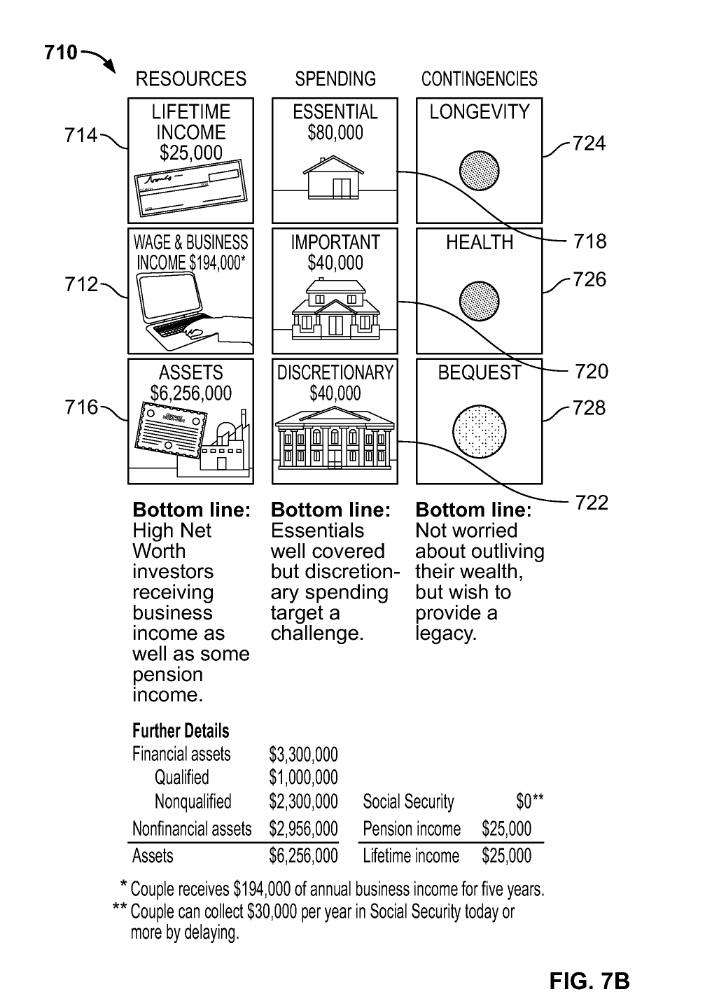

FIG. 7A shows the Baker's investment personality. Janet and Bill Baker are both 65 years old and seek to retire in five years. Bill, an experienced investor, takes the lead in making the couple's investment decisions 702. Generally unperturbed by market fluctuations, he is willing to hold less accessible investments he finds attractive 704 (FIG. 7A). The couple is not too worried about exhausting their wealth and wants to leave bequests to their children and to charity 706.

FIG. 7B shows the Baker's retirement fitness 710. The Bakers run a small business, from which they expect to earn $194,000 per year over the next five years. Janet receives a $25,000 annual pension from her former employer, and the couple currently qualifies to collect $30,000 per year in Social Security, which they might opt to defer. The Bakers have financial assets worth $3,300,000, of which $1,000,000 is in retirement accounts 716.

They also have nonfinancial assets worth nearly $3 million, chiefly their business and two homes.

The Bakers plan to spend $80,000 per year on essential expenses 718, $40,000 on important expenses and, if possible 720, $40,000 per year on discretionary expenses 722.

These expenditures are with after-tax dollars and are expected to grow in line with inflation. The couple also wants to be highly (at least 95%) confident of their ability to fund any long-term care expenses 724, 726 they may face in the future and wishes to leave bequests 728 whose values total one-half of their current investable assets, or $1,650,000.²² ²² Our analysis of this archetype, as well as the others, makes specific assumptions regarding spending goals. In particular, it assumes that the retirees require: 95% confidence in covering their essential expenses and long-term care costs; 75% confidence in covering their important expenses and in meeting their bequest goals; and 55% confidence in funding their discretionary expenses. Each of the traditional investment and retirement outcome solutions that we present achieves each these goals at consistent levels of confidence. Thus, when we contrast the solutions, it is an apples-to-apples comparison.

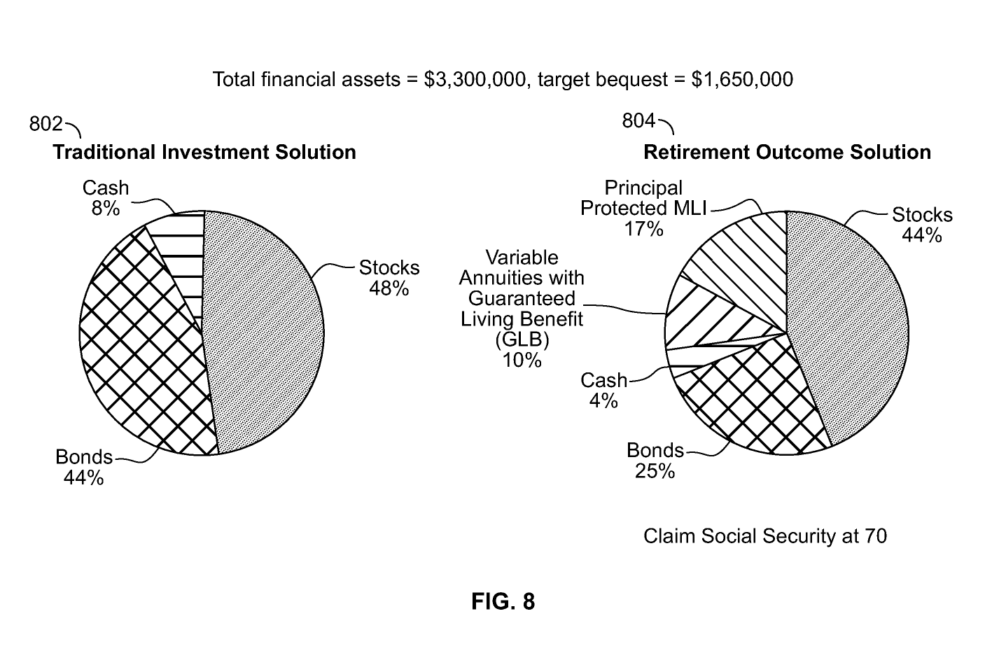

One option for the Bakers is a traditional investment solution. The asset mix that meets their goals at minimum cost is 48% in stocks, 44% in bonds and 8% in cash (FIG. 8, left pie 802).

This strategy may allow the Bakers to spend $124,000 per year—$80,000 on essentials, $40,000 on important expenses and $4,000 of discretionary spending.

They will also be able to meet their bequest goal and be highly confident of their ability to cover all future long-term care expenses.

FIG. 8 also shows a retirement outcome solution 804. The retirement outcome solution offers the Bakers a more financially and personally satisfying outcome. Bill, who likes to engage actively in markets, finds MLI appealing because they provide downside protection while allowing him to participate and profit from rising markets.²³ He therefore allocates 17% to MLI. Bill appreciates that variable annuities also offer downside protection and control over his or her investment choices, but prefers to limit the couple's variable annuity allocation to 10% because of fees. The Bakers also delay receiving Social Security until age 70. ²³ This analysis considers a market-linked investment that, after five years, pays a return equal to the capital appreciation of the Standard & Poor's 500 index, up to a cap. If the S&P 500 declines over the five year period, investors receive their original principal.

The cumulative impact of these changes is appreciable. By adopting the retirement outcome solution, the Bakers will be able to spend $138,000 per year, as opposed to $124,000 available from a traditional investment solution, while still meeting their bequest and long-term care goals. Thus, they would be able to fund $18,000 per year of discretionary expenses as opposed to $4,000 per year with a traditional investment solution.

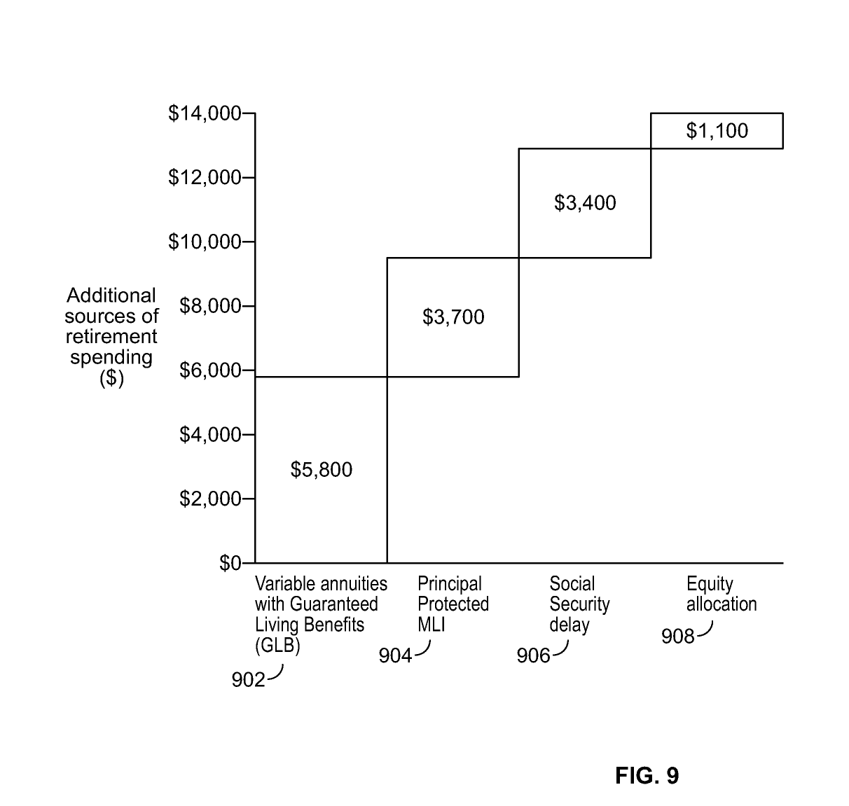

FIG. 9 shows that this incremental spending capacity comes from several sources.

The variable annuities 902 to which the Bakers allocate 10% of their investable assets ($330,000) carry a guaranteed living benefit that partially hedges market risk. The annuities, because they provide income for life, also partially hedge longevity risk. All told, these annuities facilitate an additional $5,800 of annual spending.

The principal-protected MLI 904, whose allocation is 17% ($561,000), also partially hedges market risk, freeing up an additional $3,700 of annual spending.

Delaying Social Security 906 to age 70 is yet another longevity risk hedge because it creates more annual income for life. This boosts spending by $3,400 per year.

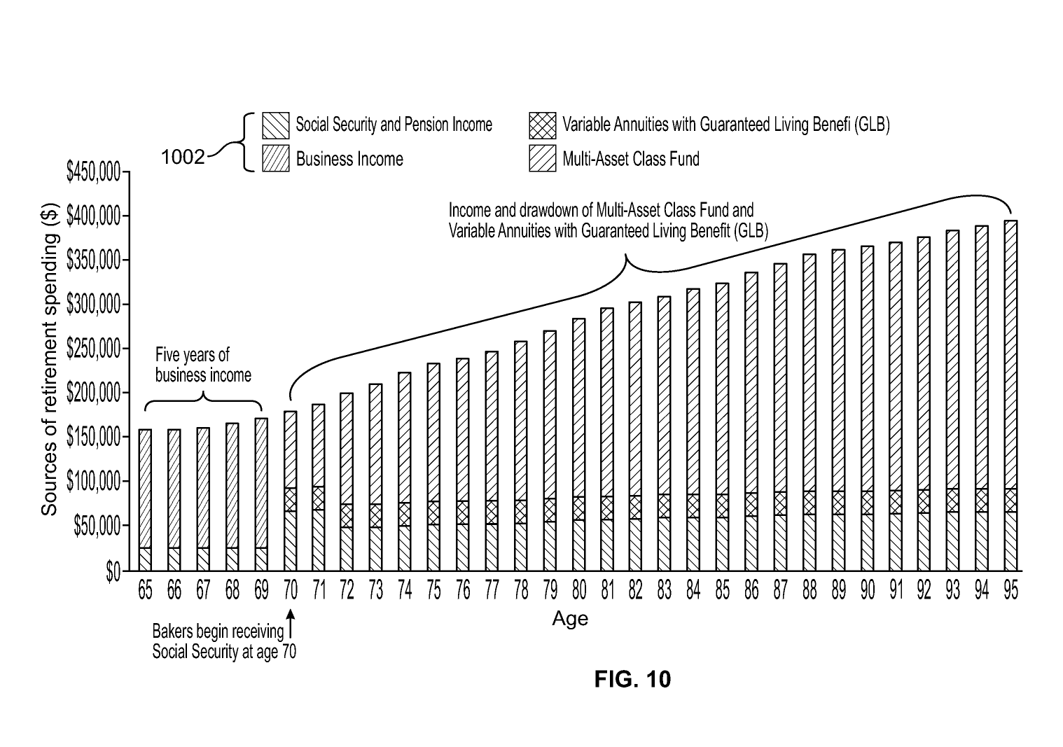

The multi-asset class fund in the retirement outcome solution has a slightly higher equity allocation 908 than does the traditional investment solution (60% vs. 48%). This generates higher returns, which facilitate an additional $1,100 per year in spending. Aside from allowing the couple to spend more each year, the retirement outcome solution enhances their retirement safety net. Since the retirement outcome solution generates income from a variety of sources 1002, as shown in FIG. 10, the Bakers will fare better even if they fail to meet their spending goals.

If the couple adopts a traditional investment solution and runs out of money, they must thereafter live on Social Security and Janet's pension. The retirement outcome solution, by contrast, generates an additional income stream from a variable annuity, and further boosts the couple's lifetime income by increasing their monthly Social Security payments.

### Exemplary Embodiment 2

### Ray Brown

Ray Brown, a 65-year-old divorcé, has three key retirement concerns. Ray wants to: ensure that he does not outlive his wealth; be highly (95%) confident that he will be financially prepared should his health deteriorate; and leave a bequest to his children.

Ray has limited investing experience and little interest in investing. He prefers to have a financial advisor manage his assets. Ray is uncomfortable with market volatility and therefore favors a conservative investment approach.

Ray has $613,000 of investable assets and two sources of retirement income. He plans to continue working as a freelance writer, from which earns $21,000 per year. He also qualifies to receive $25,000 per year in Social Security. Ray's annual expenses are $25,000 for essentials, $15,000 for important expenses and $15,000 for discretionary expenses.

Without long-term care insurance, Ray would be vulnerable. Ray could incur hundreds of thousands of dollars in expenses should he require nursing home care in his later years, his desire to guard against this possibility and to leave a bequest would force him to limit his annual spending to $35,000. Thus, he would only be able to cover his $25,000 of essential expenses and $10,000 of his $15,000 of important expenses.

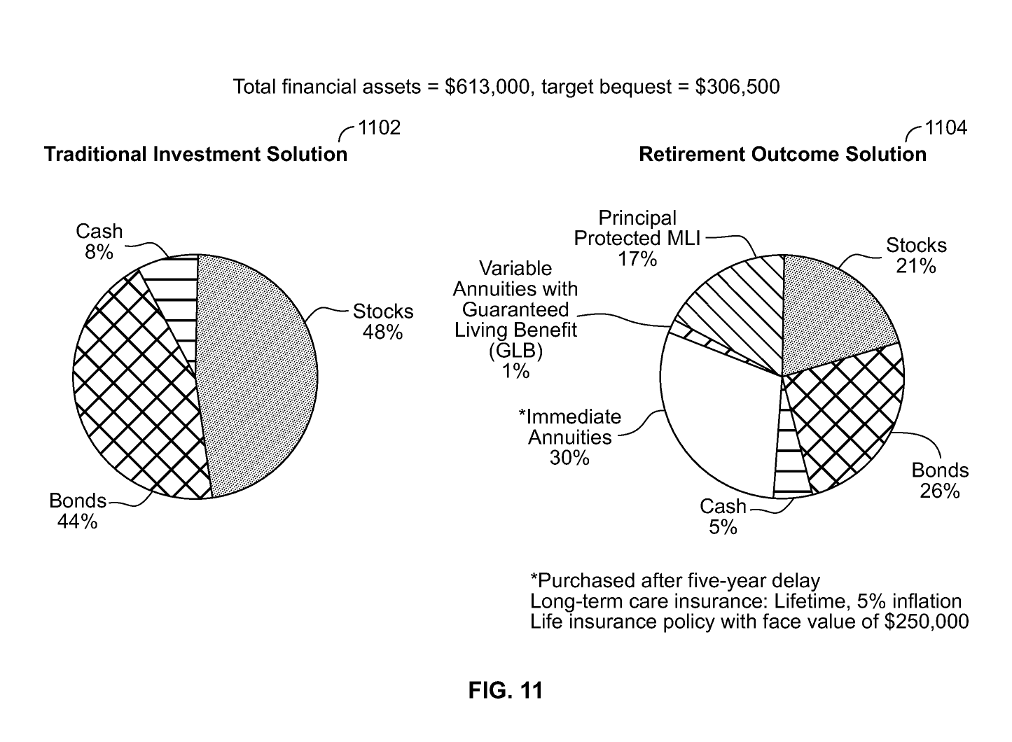

FIG. 11 shows a traditional investment solution 1102 in which Ray is invested with cash 8%, stock 48%, and bonds 44%. An exemplary outcome solution is shown at 1104.

The linchpin of Ray's retirement outcome solution 1104 is a long-term care policy that frees him from the lingering financial uncertainty due to the possibility of a major long-term-care expense down the road. The policy he purchases, whose lifetime benefit grows 5% per year to offset medical inflation, carries a high premium. To fund these premiums, Ray purchases an immediate annuity for approximately $180,000, waiting five years to make the purchase.

This delay offers two benefits. First, buying an immediate annuity at age 70 as opposed to age 65 means receiving higher monthly payments for life.

Second, Ray's financial advisor notes that interest rates are currently at historically low levels, and there is a reasonable chance that they will rebound over the next several years. Because immediate annuities are priced based on interest rates, this would translate into even higher monthly payments.

To conform to Ray's discomfort with market volatility, the retirement outcome solution holds 21% in equities, as opposed to 48% for the traditional investment solution.

Moreover, 17% of the retirement outcome solution is allocated to a principal-protected, market-linked investment (MLI). This eases Ray's concerns about market fluctuations. Finally, to help him meet his target bequest of $306,500, or one-half of his current investable assets, Ray purchases a $250,000 life insurance policy.

Freed from the financial worries concerning long-term care, market volatility and his bequest goal, Ray can more securely spend the income he receives from work, Social Security and his investments. All told, he can spend $44,000 per year, as opposed to $35,000 per year with a traditional investment solution 1102. In other words, he can meet all his essential and important expenses as well as $4,000 per year of discretionary expenses. Thus, Ray's retirement outcome solution lets him enjoy more of the fruits of his labor while meeting his key retirement goals of financial security, health care and bequest.

### Exemplary Embodiment 3

### The Millers

Barbara and Bob Miller, both 75 years old, are inexperienced investors uncertain about the future of markets. They seek principal protection, stable returns and ready access to their savings. They make all their key investment decisions together and work with a trusted financial advisor so that they can spend their golden years on interests outside of investing. Their chief financial concerns center on assuring (with 95% confidence) that they will not run out of money and that they can afford health care. Because their children are well established, they feel that leaving a bequest is not a priority, though they would be glad to do so if feasible. More importantly, they want to ensure they do not become a financial burden on their children.

The Millers have investable assets of $1.25 million, of which about $250,000 is in retirement accounts. They receive no wage or business income, but Bob does receive a $20,000 annual pension. In addition, the couple receives $20,000 per year in Social Security. They have $25,000 per year of essential expenses, $15,000 of important expenses and $25,000 per year of discretionary expenses.

A traditional investment solution may allow the Millers to cover all their essential and important expenses, as well as $13,000 of their $25,000 in discretionary expenses. They would also be highly confident of their ability to meet long-term care expenses.

The Millers' financial advisor proposes a retirement outcome solution, according to the invention, that is more broadly diversified than the traditional investment solution. Complementing their stocks, bonds and cash, the solution includes allocations to variable and immediate annuities.

The variable annuity, worth $125,000, has a guaranteed living benefit that provides lifetime income. It also offers the Millers access to the underlying assets, should the need arise. The couple also allocates $62,500 to an immediate annuity that pays regular monthly income as long as either Bob or Barbara is alive. Because the couple is 75, this income will be much higher than they could earn from bonds, although they will receive no return of principal when they die.

Finally, their financial advisor suggests that they purchase MLI, limiting their exposure to 10% (or $125,000) because of their lack of familiarity with the instrument.

Reducing their stock allocation from 49% to 30% leaves the Millers less exposed to market declines that could erode their nest egg, while still allowing them to participate in rising markets through their MLI and variable annuity holdings.

Such a retirement outcome solution offers three additional advantages over the traditional investment solution.

First, by offering downside protection in the event that markets decline, it provides the Millers investment outcomes with which they feel more comfortable. Second, it allows them to spend $55,000 per year, as opposed to $53,000 with the traditional investment solution. Finally, the variable and immediate annuities that are part of the solution offer the Millers additional lifetime income that complements their Social Security and pension, irrespective of how markets fare.

### Exemplary Embodiment 4

### Samantha Taylor

Investment personality. Samantha Taylor's portfolio has decreased significantly in value due to some poor-performing investments. She therefore favors straightforward investment choices and is uncomfortable with financial markets.

She seeks principal protection, low volatility and a reasonable level of liquidity. She loves hosting her children and grandchildren in her two homes, but wants to make sure she can maintain this lifestyle without running out of money. Samantha wants to leave a large legacy to her favorite charity, but gives less priority to providing inheritances to her children, for fear of spoiling them.

Samantha has $5.7 million of investable assets. She receives an annual pension of $40,000 as well as $20,000 per year in Social Security. She seeks to spend $280,000 per year to maintain her lifestyle: $80,000 in essentials, $80,000 in important expenses and $120,000 in discretionary expenses. She also wishes to leave half of her investable assets to her alma mater to endow a chair in French literature, a lifelong passion.

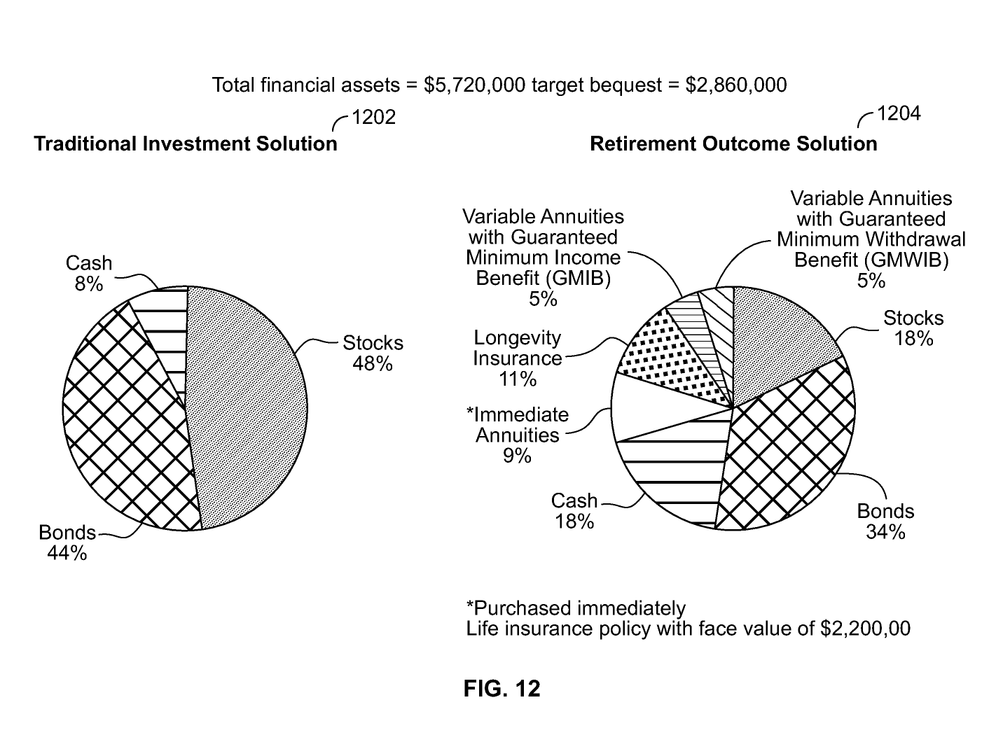

FIG. 12 shows a traditional investment solution 1202. This traditional investment solution 1202 would allow Samantha to fund her essential and important expenses, which total $160,000, but only $58,000 of her $120,000 of discretionary expenses.

FIG. 12 also shows a retirement outcome solution 1204. Given Samantha's preference for straightforward investments, she does not feel comfortable owning market-linked investments.

Samantha also wishes to limit her equity exposure to 20% of the portfolio.

Her financial advisor proposes a retirement outcome strategy, whereby Samantha would allocate: 9% to immediate annuities; 11% to longevity insurance, which pays income for life once she reaches age 85; 5% to variable annuities with a guaranteed minimum withdrawal benefit; and 5% to variable annuities with a guaranteed minimum income benefit.

She also advises Samantha to purchase a $2.2 million life insurance policy to help meet her wealth-transfer goal.

This highly diversified retirement outcome solution would allow Samantha to spend $237,000 per year, as opposed to $218,000 with the traditional investment solution, and would keep her on track to meet her bequest goals.

Moreover, she would run no greater risk of exhausting her wealth and, in the unlikely event this did happen, she would have more income for life.

A framework according to the invention enables each investor to work with her financial advisor to develop a retirement solution that is more financially and personally satisfying.

As will be appreciated by one of skill in the art, the invention described herein may be embodied in whole or in part as a method, a data processing system, or a computer program product. Accordingly, the invention may take the form of an entirely hardware embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, flash devices and/or any combination thereof. In addition, various signals representing data or events as described herein may be transferred between a source and a destination in the form of electromagnetic waves traveling through signal-conducting media such as metal wires, optical fibers, and/or wireless transmission media—e.g., air and/or space.

Data may move between various entities in any of the embodiments of the invention via electronic transmission or manual means. Electronic transmission may utilize email, SMS or any other suitable method. Manual exchange may utilize floppy disks, USB drives, CDs, DVDs or any other suitable mechanism.

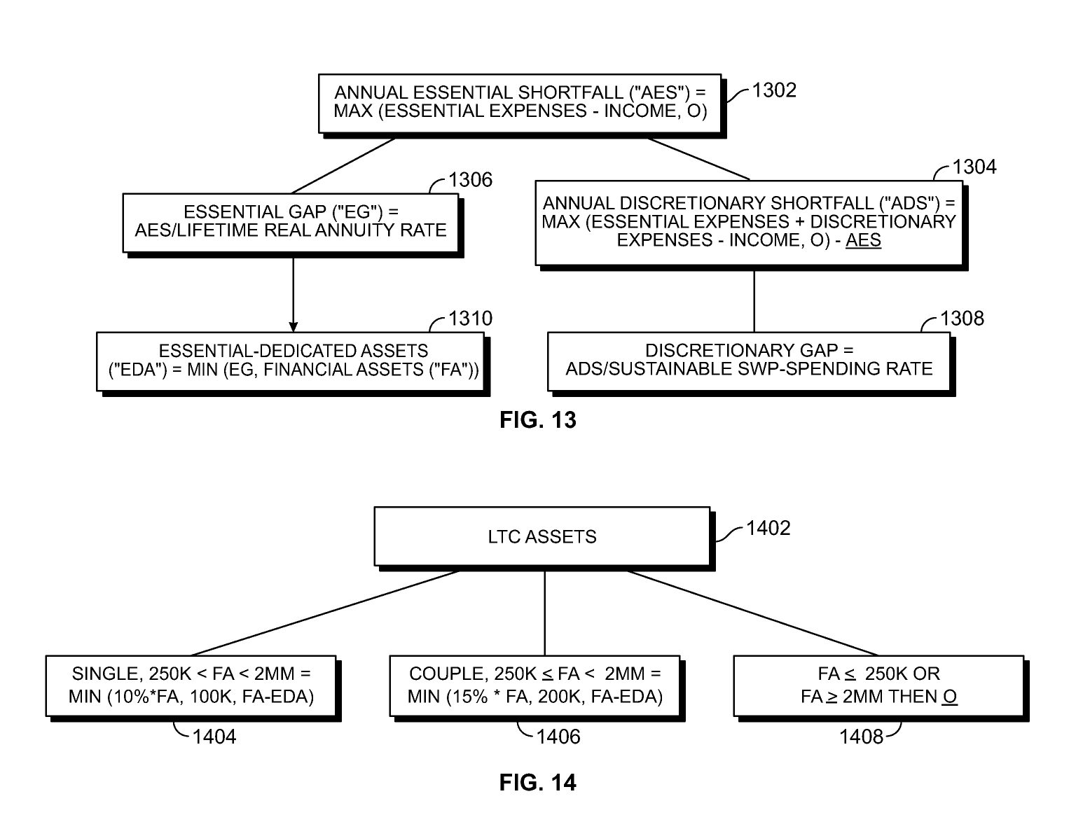

The exemplary formulas in Table 1 below relate to specific navigation logic. These formulas may be used for the formulation of one or more retirement outcome frameworks. It should be noted that the formulas set forth in Table 1 are explained in more detail in the portion of the specification corresponding to FIGS. 13-18, set forth below.

It should be noted that all the amounts and values set forth in Table 1, and in the rest of this application, are merely exemplary and that one skilled in the art may use other suitable amounts and/or values to complete retirement outcome frameworks without departing from the scope of this invention.

The following are acronyms used in Table 1:

SWP—Systematic Withdrawal Program—an SWP regularly draws down a percentage of a portfolio's assets to provide income, and then rebalances the remaining assets to a target allocation

### FA—Financial Assets

IA—Immediate Annuities—an immediate annuity makes fixed, regular payments either for life, or for a set period of time

### LTC—Long-Term Care

MLI—Market-Linked Investments—Principal-protected, Market-Linked investments are designed to give exposure to the upside performance of a market index or other asset while generally not subjecting the investment to substantially any of its declines.

TABLE 1

| Determined Quantity | Formula |
|---|---|
| Annual essential | Max (Essential expenses-income, 0) |
| shortfall (“AES”) | (for the purposes of this application, the |
| | “Max” function may obtain the maximum |
| | value from the operands in the |
| | parentheses.) |
| Annual discretionary | Max (Essential expenses + Discretionary |
| shortfall (“ADS”) | expenses-Income, 0)-Annual essential |
| | shortfall |
| Essential gap (“EG”) | AES/ |
| | Lifetime real annuity rate |
| Discretionary gap | ADS/Sustainable SWP spending rate |
| (“DG”) | |
| Essential-dedicated | Min (EG, Financial assets (“FA”)) |
| assets (“EDA”) | (for the purposes of this application, the |
| | “Min” function may obtain the minimum |
| | value from the operands in the |
| | parentheses.) |
| LTC assets (“LTC”) | |
| Single, $250K ≦ FA ≦ | Min (10% * FA, $100,000, FA-EDA) |
| $2 MM (million) | |
| Couple, $250K ≦ FA ≦ | Min (15% * FA, $200,000, FA-EDA) |
| $2 MM | |
| FA ≦ $250K or FA ≧ | 0 |
| $2 MM | |
| Discretionary- | Min (DG, FA-EDA-LTC) |
| dedicated assets | |
| (“DDA”) | |
| Wealth accumulation | FA-EDA-LTC-DDA |
| assets⁽¹⁾ (“WAA”) | |
| Annuity purchase⁽²⁾ | Min (Annuity Cap⁽³⁾ * FA, EDA) |
| (“AP”) | |
| Essential SWP | EDA-AP |
| purchase⁽⁴⁾ | |
| MLI purchase | Min (MLI Cap⁽⁵⁾ * FA, DDA) |
| Discretionary SWP | DDA-MLI purchase |
| purchase⁽⁶⁾ | |
| Life insurance | |
| guidance- | |
| Family ≠ High | 0 |
| Family = High | Face value = Max (20% * WWA + |
| | 50% * DDA-LTC, 0) |

### Notes for Table 1

(1) Exemplary Wealth accumulation asset allocation: 60% equity, 35% fixed income, 5% cash.
(2) Define the variables Accessibility, Activity, Family and Protection on a scale of 1 (low), 2 (moderate) or 3 (high).
(3) Exemplary Annuity purchase allocated to: variable annuities (“VA”) with guaranteed living benefits (“GLB”), immediate annuities and longevity insurance.
a. If investor reports health as poor, allocate purchase 100% to VA.
b. If investor reports health as excellent or moderate, define:

Annuity preference=Accessibility+2×Activity+Family,
and allocate according to Table 2:

TABLE 2

| | ANNUITY ALLOCATION | | |
|---|---|---|---|
| Annuity | Variable | Immediate | Longevity |
| preference | annuities | annuities | insurance |
| 4 or 5 | 0% | 85% | 15% |
| 6 or 7 | 50% | 42.5% | 7.5% |
| 8-12 | 100% | 0% | 0% |

(4) The annuity cap may be the maximum share of financial assets that an investor allocates to annuities.
Define Comfort with annuities=Protection−Activity;
and set the cap according to Table 3:

TABLE 3

| Comfort with | |
|---|---|
| annuities | Annuity cap |
| + | 30% |
| 0 | 20% |
| − | 10% |

(5) The SWP that covers essential expenses is allocated according to Equity Preference, defined as, Equity preference=Protection+Accessibility and as set forth in Table 4:

TABLE 4

| Equity | ASSET ALLOCATION | | |
|---|---|---|---|
| preference | Stocks | Bonds | Cash |
| 2 or 3 | 60% | 35% | 5% |
| 4 or 5 | 40% | 50% | 10% |
| 6 | 30% | 55% | 15% |

(6) The MLI cap depends on the desired level of Protection, as shown in Table 5:

TABLE 5

| Protection | MLI cap |
|---|---|
| High | 20% |
| Moderate or | 10% |
| Low | |

(7) Exemplary allocation of SWP that covers discretionary expenses: 50% equity, 40% fixed income, 10% cash.

Summary:

Exemplary impact of factors on asset allocations, as shown in Table 6.

TABLE 6

| | IMPACT ON ALLOCATION TO: | | | | |
|---|---|---|---|---|---|
| | Variable | Immediate | | | Fixed |
| Factor | annuity | annuity | MLI | Equity | income |
| Protection | + | + | + | − | ? |
| Activity | ? | − | | + | + |
| Accessibility | + | − | | − | + |
| Family | + | − | | | |
| Health | − | + | | | |

The following flow charts in FIGS. 13-18 correspond to the navigation framework set forth above. Again, it should be noted that the navigation framework(s) set forth herein are exemplary and one skilled in the art may use other suitable frameworks without departing from the scope of this invention.

As described above with respect to FIG. 5, retirement resource allocations consist of three basic components: (1) a lifetime income floor that assures some minimum level of income for life; (2) contingency protection to address potentially-devastating life-cycle risks; and (3) a portfolio designed to provide inflation protection and bequest potential, while offering flexibility and upside.

As described above in Table 1, key framework principles include funding essential expenses principally with annuities; supporting discretionary spending with an SWP; providing LTC insurance to investors with financial assets up to two million dollars; and recommending life insurance to investors for whom family is a high priority.

As set forth above in the portion of the specification corresponding to FIG. 6, funding essential expenses principally with annuities may include the following specific instructions. Cap annuity allocation at 30% of total financial assets. The annuity cap may be less for investors seeking activity but not protection. The split between variable and immediate annuities may be configured to depends on activity, accessibility, family and health. In addition, up to fifteen percent, or some other suitable percentage, of immediate annuity allocation may be directed to longevity insurance that pays out at age 85.

The specific instructions may include supporting discretionary spending with an SWP according to the invention. Withdrawal rates may preferably be based on a sound analysis such as, for example, the Merrill Lynch Wealth Management analysis.²⁴ Equity allocation may depend on investor preferences for protection and accessibility. In addition, the network may provide guidance that supplements traditional investment with a market-linked allocation of up to 20% of financial assets. ²⁴ See, e.g., David Laster, Nevenka Vrdoljak and Anil Suri, “Systematic Withdrawal Strategies for Retirees,” Merrill Lynch Management Institute, Winter 2012.

As set forth in detail in Table 1, another of the principles may include providing LTC insurance to investors with financial assets up to two million dollars. This principle may further include using a single-premium policy that combines long-term care coverage with traditional life insurance. For single investors, the instructions may include allocating 10% of financial assets up to $100,000. For couples, the instructions may include allocating 15% of financial assets up to $200,000.

The instructions may also include recommending life insurance to investors for whom family is a high priority. In one embodiment of the instructions according to the invention, the guidance may fund life insurance after meeting essential and discretionary expenses. In addition, a bequest may further include balance remaining in Systematic Withdrawal Program, death benefit from insurance policies as well as guaranteed payments for certain annuity contracts.

FIGS. 13-18 are illustrative flow diagrams that graphically illustrate possible navigational formulas that correspond to certain embodiments of systems and methods. It should be noted that the illustrative flow diagrams further correspond to the formulas set forth in Table 1, above.

FIG. 13 shows an illustrative flow chart directed to a portion of a retirement fitness calculus. Such a calculus may be used to show that the annual essential shortfall (“AES”)—i.e., the amount of funds needed to pay for essential needs over and above income—may be determined based on the greater of either (essential expenses-income) or zero over any suitable predetermined amount of time. It should be noted that, unless otherwise specified, the values, such as essential expenses or income, set forth herein are with respect to any suitable period of time, e.g., one year.

As described above, AES 1302 is formed from obtaining the maximum of (essential expenses−income) and 0. AES may then be used for obtaining ADS 1304 and EG 1306, as explained in more detail below.

EG 1306 may be obtained by dividing AES 1302 by a lifetime real annuity rate. Such a lifetime real annuity rate may represent the rate of return of a lifetime immediate annuity whose payout rises with inflation. If, for example, the lifetime real annuity rate is 4.5%, then a $100,000 annuity would pay $4,500 this year and amounts that rise with inflation in later years. Accordingly, EG 1306 may represent the amount of capital needed to pay for the person's essential needs, using an immediate annuity vehicle. As such, EG 1306 may represent the total amount of funds needed to insure that an investor's essential needs are met going forward.

DG 1308 is obtained by dividing ADS 1304 by the sustainable SWP spending rate. The SWP spending rate is obtained, in one exemplary embodiment of the invention, by how much an investor can sustainably spend from a balanced fund—e.g., 40% stock, 50% bond, 10% cash—while being 75% assured of never running out of assets. If it is 6.5%, then an investor could spend $6500 from a $100,000 account the first year, and increase this spending each year with inflation. Accordingly, DG 1308 is obtained by taking the maximum of essential expenses plus the discretionary expenses minus income, and 0.

This maximum is reduced by the annual essential shortfall to obtain the discretionary gap—i.e., the total amount of funds needed to insure that an investor's stated discretionary needs are met going forward.

EDA 1310 may be obtained by taking the minimum value from either the EG or FA. Thus, the essential-dedicated assets may be the lesser of the essential gap and the financial assets.

FIG. 14 shows that LTC 1402 may preferably be grouped into three (or more, or less) categories. LTC 1402 may preferably be grouped as a single individual 1404 having assets of between $250K≦FA≦$2 MM, a couple 1406 having assets of between $250K≦FA≦$2 MM or for any single or couple 1408 having assets of between FA≦$250K or FA≧$2 MM.

A single individual having assets of between $250K≦FA≦$2 MM may preferably opt for the minimum of 10%*FA; $100,000; and FA−EDA. A couple having assets of between $250K≦FA≦$2 MM may preferably opt for the minimum of 15%*FA, $200,000; and FA−EDA. Either a single or a couple having assets less than 250K or greater than 2 MM may be advised not to purchase LTC 1402. Accordingly, the algorithm(s) set forth in FIG. 14 may preferably show that LTC is appropriate for anyone having financial assets between 250K and 2 MM.

In addition, with respect to a single, the amount of long-term care may be the minimum of ten percent of financial assets; 100K; and the total financial assets less the essential-dedicated assets. The couple may require coverage for fifteen percent of financial assets instead of ten percent.

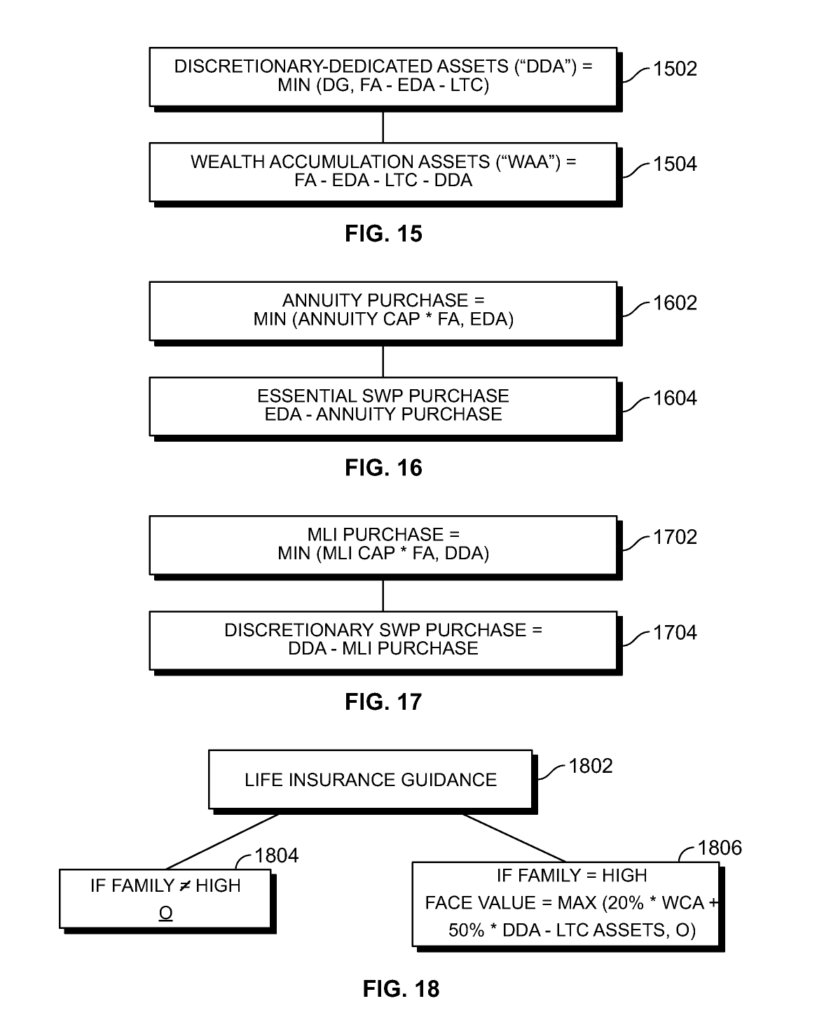

FIG. 15 shows a calculation 1502 of DDA as representing a minimum of the DG and FA-EDA-LTC. Thus, discretionary dedicated assets may be determined by a minimum of either the discretionary gap or the financial assets less the essential-dedicated assets less the cost long-term care coverage.

A calculation for WAA 1504 may preferably include FA-EDA-LTC-DDA. The wealth accumulation assets is whatever remains from the financial assets after the essential-dedicated assets, the cost of long-term care coverage and the discretionary dedicated assets have been removed.

FIG. 16 shows a calculation 1602 of an annuity purchase as corresponding to the minimum of an annuity cap*FA and EDA. The logic for obtaining an exemplary annuity cap is set forth above in table 3. In one understanding of an annuity cap, the cap may be defined by the maximum share of financial assets that an investor allocates to annuities. In one embodiment, the annuity cap may depend on Comfort with annuities=Protection−Activity

An essential SWP purchase 1604 may be obtained by subtracting the annuity purchase from the EDA.

FIG. 17 shows a calculation 1702 of an MLI purchase as corresponding to the minimum of an MLI cap*FA and DDA. A discretionary SWP purchase 1704 may be obtained by subtracting the MLI purchase from the DDA. A discretionary SWP purchase 1704 may further be guided by the factors set forth above in table 6.

FIG. 18 shows a calculation for life insurance guidance 1802. Such a calculation may be based on whether the investor considers family a high priority in the investor's life.

If the investor does not consider family a high priority 1804, then the guidance may set the life insurance purchase to zero. If the investor does consider family a high priority 1806, then the guidance may set the life insurance purchase face value to the maximum of (20%*WAA+50%*DDA−LTC) and zero. Thus, an individual's life insurance purchase may be some know percentage of wealth accumulation assets plus some known percentage of discretionary dedicated assets less the amount necessary for the purchase of long term care coverage.

As set forth above, the various factors that form an investor's personality, such as investment mindset, investment approach and investment purpose have been used to chart an investment personality. Thereafter, a determination is obtained regarding the investor's retirement fitness. Such a determination may include the investor's essential expenses, income, assets and discretionary expenses. The investment personality may be combined with the retirement fitness using navigation guidelines to obtain a set of retirement goal-driven recommendations.

Thus, apparatus and methods that provide navigation logic construct(s) for retirement outcome framework(s) are provided.

Persons skilled in the art will appreciate that the present invention can be practiced by other than the described embodiments, which are presented for purposes of illustration rather than of limitation, and that the present invention is limited only by the claims that follow.

What is claimed is:

1. A method for navigating to one or more customized, goals-based retirement outcome solution(s), the method comprising:
using a receiver to receive essential expense information from an investor;
using the receiver to receive income information from the investor;
using a processor to calculate:
Max(Essential expenses−income,0)=AES
where (“AES”) represents the annual essential shortfall value (“AES”);
using the receiver to receive information corresponding to a lifetime real annuity rate; and
using the processor to calculate:
AES/lifetime real annuity rate=EG
where (“EG”) represents an essential gap value.

2. The method of claim 1 further comprising using the receiver to receive discretionary expense information from the investor and using the processor to calculate:
Max(Essential expenses+Discretionary expenses−Income,0)−Annual essential shortfall=ADS
where (“ADS”) represents an annual discretionary shortfall value.

3. The method of claim 2 further comprising using the receiver to receive sustainable systematic withdrawal plan (“SWP”) rate information from the investor and using the processor to calculate:
ADS/SWP=DG
where (“DG”) a discretionary gap value.

4. The method of claim 1, further comprising using the receiver to receive financial asset information (“FA”) and using the processor to calculate:
Min(EG,FA)=EDA
where (“EDA”) represents an essential-dedicated assets value.

5. The method of claim 4, further comprising using the receiver to receive sustainable systematic withdrawal plan (“SWP”) rate information and long term care coverage information (“LTC”) from the investor and using the processor to calculate:
ADS/SWP=DG
where (“DG”) represents a discretionary gap value;
and using the processor to calculate:
Min(DG,FA−EDA−LTC)=DDA
where (“DDA”) represents a discretionary-dedicated assets value.

6. The method of claim 5, further comprising using the processor to calculate:
FA−EDA−LTC−DDA=WAA
where (“WAA”) represents a wealth-accumulation assets value.

7. The method of claim 4, further comprising using the receiver to receive an annuity cap value and using the processor to calculate:
Min(Annuity Cap*FA,EDA)=AP
where (“AP”) represents an annuity purchase value.

8. The method of claim 7, further comprising using the processor to calculate:
EDA−AP=ESP
where (“ESP”) represents an essential systematic withdrawal plan (“SWP”) purchase.

9. The method of claim 5, further comprising using the receiver to receive a market-linked investment (“MLI”) value and using the processor to calculate:
Min(MLI Cap*FA,DDA)=MLIP
where (“MLIP”) represents a market-linked investment purchase value.

10. The method of claim 9, further comprising using the processor to calculate:
DDA−MLIP=DSWPP
where (“DSWPP”) represents a discretionary SWP purchase value.

11. One or more non-transitory computer readable media having code stored thereon which, when executed by a processor, facilitates a method for coordinating a retirement outcome framework, the method comprising:
using a receiver to receive essential expense information from an investor;
using the receiver to receive income information from the investor;
using a processor to calculate:
Max(Essential expenses−income,0)=AES
where (“AES”) represents the annual essential shortfall value (“AES”);
using the receiver to determine a lifetime real annuity rate; and
using the processor to calculate:
AES/lifetime real annuity rate=EG
where (“EG”) represents an essential gap value.

12. Apparatus for utilizing results from a set of questions directed to an investor's mindset to obtain one or more customized, goals-based, retirement outcome solution(s), the apparatus comprising:
a receiver that is configured to receive the results, wherein the results correspond to investor mindset, investor approach and investor purpose, and the receiver is further configured to receive information based on the investor's retirement fitness, the information based on the investor's retirement fitness including information directed to the investor's resources, spending and contingencies
a processor that is configured to register in a machine readable memory information based on the results and based on the investor's retirement fitness information, wherein the processor is further configured to register in a machine readable memory an annual essential shortfall value (“AES”), wherein the AES is based on:
Max(Essential expenses−income,0)=AES
and the essential expenses and the income are derived from investor's retirement fitness information.

13. The apparatus of claim 12, wherein the receiver is further configured to receive information corresponding to a lifetime real annuity rate; and
the processor is further configured to register in a machine-readable memory an essential gap value (“EG”), said EG being derived by:
AES/lifetime real annuity rate=EG.

14. The apparatus of claim 12, wherein the results corresponding to investor mindset are obtained in response to at least one query, said at least one query selected from a group consisting of a plurality of queries directed to investor confidence, investor adaptability and investor experience.

15. The apparatus of claim 14, wherein one of the plurality of queries directed to investor confidence is selected from a group consisting of determining investor reaction to the statement “Risk may yield financial benefits if I wait long enough,” “To me, investing is something that everyone should take part in. Sure, there are some risks, but the potential rewards are worth it,” and “Just thinking about financial markets makes me anxious—even when markets are going up.”

16. The apparatus of claim 14, wherein one of the plurality of queries directed to investor adaptability is selected from a group consisting of determining investor reaction to the statement “I can adjust my lifestyle and income needs to accommodate changes in market conditions and in the value of my investments,” “I feel most comfortable knowing that I can rely on a steady stream of income, yield or return from my investments,” and “Spending my principal (or original investment) is something I would prefer not to do.”

17. The apparatus of claim 14, wherein one of the plurality of queries directed to investor experience is selected from a group consisting of “I have spent many years—even decades—investing,” “Following market news and reading investment-related publications or books is something that I do on a regular basis,” and “I know less than the average investor about financial markets and investing in general.”

18. The apparatus of claim 12, wherein one of the plurality of queries directed to asset accessibility is selected from a group consisting of determining investor reaction to the statement “I feel that I may have an unforeseen need for a large amount of money in the future,” “I want the ability to withdraw money from some of my investments at any point in time—regardless of the cost” and “The flexibility to change my investment approach dramatically—at a moment's notice—is important to me, even though it may come at a cost.”

19. The apparatus of claim 12, wherein one of the plurality of queries directed to asset protection is selected from a group consisting of determining investor reaction to the statement “I do not worry about losing my principal (or original investment),” “I understand that the possibility of losing money is part of the investment process” and “Losing even a small amount of money can make me feel anxious.”

20. The apparatus of claim 12, wherein one of the plurality of queries directed to investor activity is selected from a group consisting of determining investor reaction to the statement “I would personally like to make regular changes to my investment approach in an attempt to improve my investment returns,” “Being involved in detailed, day-to-day investment decisions is important to me” and “A financial advisor or money manager can help me make investment decisions that can enhance investment outcomes.”

21. The apparatus of claim 12, wherein one of the plurality of queries directed to asset protection is selected from a group consisting of determining investor reaction to the statement “I do not worry about losing my principal (or original investment),” “I understand that the possibility of losing money is part of the investment process” and “Losing even a small amount of money can make me feel anxious.”

22. The apparatus of claim 12, wherein the results corresponding to investor approach are obtained in response to at least one query, said at least one query selected from a group consisting of a plurality of queries directed to asset accessibility, asset protection and investor activity.

23. The apparatus of claim 12, wherein the results corresponding to investor purpose are obtained in response to at least one query, said at least one query selected from a group consisting of a plurality of queries directed to importance of investing for self, importance of investing for family and importance of investing for the community.
